(19) United States
(12) Patent Application Publication
(10) Pub. No.: US 2023/0068405 A1
(43) Pub. Date: Mar. 2, 2023

(54) Self-Contained Winch Mounting System

(71) Applicant: Kyle Herron, Pittsburg, KS (US)

(72) Inventor: Kyle Herron, Pittsburg, KS (US)

(21) Appl. No.: 17/458,084

(22) Filed: Aug. 26, 2021

(51) Int. Cl. B60P 3/12; B60P 3/07; B66D 3/00

(52) U.S. Cl. CPC B60P 3/12; B60P 3/07; B66D 3/006; B66D 2700/0191

(57) ABSTRACT

A system and method including a counter pressure mechanism with a retractable wheel lift arm that retracts into a compact position underneath a bed of a recovery vehicle when not in use; a wheel lift base plate for supporting the retractable wheel lift arm, and increasing a stability of the counter pressure mechanism while winching a vehicle for towing purposes; wherein the counter pressure mechanism is configured to be operable for transferring pressure from winching the vehicle to the wheel lift base plate and distribute the pressure into a ground; and a wheel lift bracket having adjustable arms that are configured to move in and out to adjust to different widths of vehicles. The system further including a winching mechanism having a winch implement; a winch cable; a cable guide; and a pulley device.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection by the author thereof. The copyright owner has no objection to the facsimile reproduction by anyone of the patent document or patent disclosure for the purposes of referencing as patent prior art, as it appears in the Patent and Trademark Office, patent file or records, but otherwise reserves all copyright rights whatsoever.

### BACKGROUND OF THE RELEVANT PRIOR ART

One or more embodiments of the invention generally relate to disabled vehicle recovery. More particularly, certain embodiments of the invention relate to a Back Up Recovery Device (BURD) for the efficient recovery of disabled vehicles.

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

Disabled vehicles may become hazards to a roadway, and may be difficult to recover or remove, especially on busy roads or difficult angles. As such, the efficient and prompt recovery of vehicles may be a prevent further injury or damage caused by traffic accidents, as well as clear any congestion that may be a direct cause of a collision.

The following is an example of a specific aspect in the prior art that, while expected to be helpful to further educate the reader as to additional aspects of the prior art, is not to be construed as limiting the present invention, or any embodiments thereof, to anything stated or implied therein or inferred thereupon. By way of educational background, another aspect of the prior art generally useful to be aware of is that conventional vehicle recovery means typically comprise the use of a winching mechanism attached to a recovery truck. The recovery truck typically may be, for example, without limitation, a wrecker truck, roll-back truck, etc. A roll-back truck is typically equipped with a roll-back truck bed, a winch, and an additional wheel lift carrier beneath the roll-back truck bed for the towing of additional vehicles. To recover a disabled vehicle using a roll-back truck, the roll-back truck bed may be lowered, a wire rope of the winch may be deployed, a snatch block may be attached to the roll-back truck to achieve a desired angle, wire rope or chains may be attached to the disabled vehicle, and the winch may be activated. However, attaching a snatch block to the roll-back truck bed may cause immediate or gradual damage to the roll-back truck, as the roll-back truck bed or frame of the roll-back truck may be twisted or damaged with the large amount of pressure from the winching mechanism in recovering the disabled vehicle. Additionally, snatch blocks may be damaged or may detach, and may cause serious injury or damage to objects in the immediate vicinity. While a second winch may be installed on a roll-back truck, the installment of the second winch may be time consuming, and is typically a permanent addition to the truck. Side-pull systems may also be used for vehicle recovery, but may be costly both in initial purchase and installation.

In view of the foregoing, it is clear that these traditional techniques are not perfect and leave room for more optimal approaches.

### BRIEF DESCRIPTION OF THE DRAWINGS

The present invention is illustrated by way of example, and not by way of limitation, in the figures of the accompanying drawings and in which like reference numerals refer to similar elements and in which:

FIGS. 1A-1B illustrate an exemplary self-contained winch mounting system, wherein FIG. 1A shows a top view of a self-contained mounting system and FIG. 1B shows a side view of a self-contained mounting system, in accordance with an embodiment of the present invention;

FIGS. 2A-2B illustrate an exemplary BURD, wherein FIG. 2A shows a top view of a BURD and FIG. 2B shows a side view of a BURD, in accordance with an embodiment of the present invention;

FIGS. 3A-3B illustrate an exemplary BURD, wherein FIG. 3A shows a front view of a BURD and FIG. 3B shows a side view of a BURD, in accordance with an embodiment of the present invention;

FIG. 4 illustrates a flowchart of an exemplary method for installing a BURD, in accordance with an embodiment of the present invention; and

FIG. 5 illustrates a flowchart of an exemplary method for deploying a BURD for use, in accordance with an embodiment of the present invention.

Unless otherwise indicated illustrations in the figures are not necessarily drawn to scale.

### DETAILED DESCRIPTION OF SOME EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

All words of approximation as used in the present disclosure and claims should be construed to mean “approximate,” rather than “perfect,” and may accordingly be employed as a meaningful modifier to any other word, specified parameter, quantity, quality, or concept. Words of approximation, include, yet are not limited to terms such as “substantial”, “nearly”, “almost”, “about”, “generally”, “largely”, “essentially”, “closely approximate”, etc.

As will be established in some detail below, it is well settled law, as early as 1939, that words of approximation are not indefinite in the claims even when such limits are not defined or specified in the specification.

For example, see Ex parte Mallory, 52 USPQ 297, 297 (Pat. Off. Bd. App. 1941) where the court said “The examiner has held that most of the claims are inaccurate because apparently the laminar film will not be entirely eliminated. The claims specify that the film is “substantially” eliminated and for the intended purpose, it is believed that the slight portion of the film which may remain is negligible. We are of the view, therefore, that the claims may be regarded as sufficiently accurate.”

Note that claims need only “reasonably apprise those skilled in the art” as to their scope to satisfy the definiteness requirement. See Energy Absorption Sys., Inc. v. Roadway Safety Servs., Inc., Civ. App. 96-1264, slip op. at 10 (Fed. Cir. Jul. 3, 1997) (unpublished) Hybridtech v. Monoclonal Antibodies, Inc., 802 F.2d 1367, 1385, 231 USPQ 81, 94 (Fed. Cir. 1986), cert. denied, 480 U.S. 947 (1987). In addition, the use of modifiers in the claim, like “generally” and “substantial,” does not by itself render the claims indefinite. See Seattle Box Co. v. Industrial Crating & Packing, Inc., 731 F.2d 818, 828-29, 221 USPQ 568, 575-76 (Fed. Cir. 1984).

Moreover, the ordinary and customary meaning of terms like “substantially” includes “reasonably close to: nearly, almost, about”, connoting a term of approximation. See In re Frye, Appeal No. 2009-006013, 94 USPQ2d 1072, 1077, 2010 WL 889747 (B.P.A.I. 2010) Depending on its usage, the word “substantially” can denote either language of approximation or language of magnitude. Deering Precision Instruments, L.L.C. v. Vector Distribution Sys., Inc., 347 F.3d 1314, 1323 (Fed. Cir. 2003) (recognizing the “dual ordinary meaning of th[e] term [“substantially”] as connoting a term of approximation or a term of magnitude”). Here, when referring to the “substantially halfway” limitation, the Specification uses the word “approximately” as a substitute for the word “substantially” (Fact 4). (Fact 4). The ordinary meaning of “substantially halfway” is thus reasonably close to or nearly at the midpoint between the forwardmost point of the upper or outsole and the rearwardmost point of the upper or outsole.

Similarly, the term ‘substantially’ is well recognized in case law to have the dual ordinary meaning of connoting a term of approximation or a term of magnitude. See Dana Corp. v. American Axle & Manufacturing, Inc., Civ. App. 04-1116, 2004 U.S. App. LEXIS 18265, *13-14 (Fed. Cir. Aug. 27, 2004) (unpublished). The term “substantially” is commonly used by claim drafters to indicate approximation. See Cordis Corp. v. Medtronic AVE Inc., 339 F.3d 1352, 1360 (Fed. Cir. 2003) (“The patents do not set out any numerical standard by which to determine whether the thickness of the wall surface is ‘substantially uniform.’ The term ‘substantially,’ as used in this context, denotes approximation. Thus, the walls must be of largely or approximately uniform thickness.”); see also Deering Precision Instruments, LLC v. Vector Distribution Sys., Inc., 347 F.3d 1314, 1322 (Fed. Cir. 2003); Epcon Gas Sys., Inc. v. Bauer Compressors, Inc., 279 F.3d 1022, 1031 (Fed. Cir. 2002). We find that the term “substantially” was used in just such a manner in the claims of the patents-in-suit: “substantially uniform wall thickness” denotes a wall thickness with approximate uniformity.

It should also be noted that such words of approximation as contemplated in the foregoing clearly limits the scope of claims such as saying ‘generally parallel’ such that the adverb ‘generally’ does not broaden the meaning of parallel. Accordingly, it is well settled that such words of approximation as contemplated in the foregoing (e.g., like the phrase ‘generally parallel’) envisions some amount of deviation from perfection (e.g., not exactly parallel), and that such words of approximation as contemplated in the foregoing are descriptive terms commonly used in patent claims to avoid a strict numerical boundary to the specified parameter. To the extent that the plain language of the claims relying on such words of approximation as contemplated in the foregoing are clear and uncontradicted by anything in the written description herein or the figures thereof, it is improper to rely upon the present written description, the figures, or the prosecution history to add limitations to any of the claim of the present invention with respect to such words of approximation as contemplated in the foregoing. That is, under such circumstances, relying on the written description and prosecution history to reject the ordinary and customary meanings of the words themselves is impermissible. See, for example, Liquid Dynamics Corp. v. Vaughan Co., 355 F.3d 1361, 69 USPQ2d 1595, 1600-01 (Fed. Cir. 2004). The plain language of phrase 2 requires a “substantial helical flow.” The term “substantial” is a meaningful modifier implying “approximate,” rather than “perfect.” In Cordis Corp. v. Medtronic AVE, Inc., 339 F.3d 1352, 1361 (Fed. Cir. 2003), the district court imposed a precise numeric constraint on the term “substantially uniform thickness.” We noted that the proper interpretation of this term was “of largely or approximately uniform thickness” unless something in the prosecution history imposed the “clear and unmistakable disclaimer” needed for narrowing beyond this simple-language interpretation. Id. In Anchor Wall Systems v. Rockwood Retaining Walls, Inc., 340 F.3d 1298, 1311 (Fed. Cir. 2003)” Id. at 1311. Similarly, the plain language of claim 1 requires neither a perfectly helical flow nor a flow that returns precisely to the center after one rotation (a limitation that arises only as a logical consequence of requiring a perfectly helical flow).

The reader should appreciate that case law generally recognizes a dual ordinary meaning of such words of approximation, as contemplated in the foregoing, as connoting a term of approximation or a term of magnitude; e.g., see Deering Precision Instruments, L.L.C. v. Vector Distrib. Sys., Inc., 347 F.3d 1314, 68 USPQ2d 1716, 1721 (Fed. Cir. 2003), cert. denied, 124 S. Ct. 1426 (2004) where the court was asked to construe the meaning of the term “substantially” in a patent claim. Also see Epcon, 279 F.3d at 1031 (“The phrase ‘substantially constant’ denotes language of approximation, while the phrase ‘substantially below’ signifies language of magnitude, i.e., not insubstantial.”). Also, see, e.g., Epcon Gas Sys., Inc. v. Bauer Compressors, Inc., 279 F.3d 1022 (Fed. Cir. 2002) (construing the terms “substantially constant” and “substantially below”); Zodiac Pool Care, Inc. v. Hoffinger Indus., Inc., 206 F.3d 1408 (Fed. Cir. 2000) (construing the term “substantially inward”); York Prods., Inc. v. Cent. Tractor Farm & Family Ctr., 99 F.3d 1568 (Fed. Cir. 1996) (construing the term “substantially the entire height thereof”); Tex. Instruments Inc. v. Cypress Semiconductor Corp., 90 F.3d 1558 (Fed. Cir. 1996) (construing the term “substantially in the common plane”). In conducting their analysis, the court instructed to begin with the ordinary meaning of the claim terms to one of ordinary skill in the art. Prima Tek, 318 F.3d at 1148. Reference to dictionaries and our cases indicates that the term “substantially” has numerous ordinary meanings. As the district court stated, “substantially” can mean “significantly” or “considerably.” The term “substantially” can also mean “largely” or “essentially.” Webster's New 20th Century Dictionary 1817 (1983).

Words of approximation, as contemplated in the foregoing, may also be used in phrases establishing approximate ranges or limits, where the end points are inclusive and approximate, not perfect; e.g., see AK Steel Corp. v. Sollac, 344 F.3d 1234, 68 USPQ2d 1280, 1285 (Fed. Cir. 2003) where it where the court said [W]e conclude that the ordinary meaning of the phrase “up to about 10%” includes the “about 10%” endpoint. As pointed out by AK Steel, when an object of the preposition “up to” is nonnumeric, the most natural meaning is to exclude the object (e.g., painting the wall up to the door). On the other hand, as pointed out by Sollac, when the object is a numerical limit, the normal meaning is to include that upper numerical limit (e.g., counting up to ten, seating capacity for up to seven passengers). Because we have here a numerical limit—“about 10%”—the ordinary meaning is that that endpoint is included.

In the present specification and claims, a goal of employment of such words of approximation, as contemplated in the foregoing, is to avoid a strict numerical boundary to the modified specified parameter, as sanctioned by Pall Corp. v. Micron Separations, Inc., 66 F.3d 1211, 1217, 36 USPQ2d 1225, 1229 (Fed. Cir. 1995) where it states “It is well established that when the term “substantially” serves reasonably to describe the subject matter so that its scope would be understood by persons in the field of the invention, and to distinguish the claimed subject matter from the prior art, it is not indefinite.” Likewise see Verve LLC v. Crane Cams Inc., 311 F.3d 1116, 65 USPQ2d 1051, 1054 (Fed. Cir. 2002). Expressions such as “substantially” are used in patent documents when warranted by the nature of the invention, in order to accommodate the minor variations that may be appropriate to secure the invention. Such usage may well satisfy the charge to “particularly point out and distinctly claim” the invention, 35 U.S.C. § 112, and indeed may be necessary in order to provide the inventor with the benefit of his invention. In Andrew Corp. v. Gabriel Elecs. Inc., 847 F.2d 819, 821-22, 6 USPQ2d 2010, 2013 (Fed. Cir. 1988) the court explained that usages such as “substantially equal” and “closely approximate” may serve to describe the invention with precision appropriate to the technology and without intruding on the prior art. The court again explained in Ecolab Inc. v. Envirochem, Inc., 264 F.3d 1358, 1367, 60 USPQ2d 1173, 1179 (Fed. Cir. 2001) that “like the term ‘about,’ the term ‘substantially’ is a descriptive term commonly used in patent claims to ‘avoid a strict numerical boundary to the specified parameter, see Ecolab Inc. v. Envirochem Inc., 264 F.3d 1358, 60 USPQ2d 1173, 1179 (Fed. Cir. 2001) where the court found that the use of the term “substantially” to modify the term “uniform” does not render this phrase so unclear such that there is no means by which to ascertain the claim scope.

Similarly, other courts have noted that like the term “about,” the term “substantially” is a descriptive term commonly used in patent claims to “avoid a strict numerical boundary to the specified parameter.”; e.g., see Pall Corp. v. Micron Seps., 66 F.3d 1211, 1217, 36 USPQ2d 1225, 1229 (Fed. Cir. 1995); see, e.g., Andrew Corp. v. Gabriel Elecs. Inc., 847 F.2d 819, 821-22, 6 USPQ2d 2010, 2013 (Fed. Cir. 1988) (noting that terms such as “approach each other,” “close to,” “substantially equal,” and “closely approximate” are ubiquitously used in patent claims and that such usages, when serving reasonably to describe the claimed subject matter to those of skill in the field of the invention, and to distinguish the claimed subject matter from the prior art, have been accepted in patent examination and upheld by the courts). In this case, “substantially” avoids the strict 100% nonuniformity boundary.

Indeed, the foregoing sanctioning of such words of approximation, as contemplated in the foregoing, has been established as early as 1939, see Ex parte Mallory, 52 USPQ 297, 297 (Pat. Off. Bd. App. 1941) where, for example, the court said “the claims specify that the film is “substantially” eliminated and for the intended purpose, it is believed that the slight portion of the film which may remain is negligible. We are of the view, therefore, that the claims may be regarded as sufficiently accurate.” Similarly, In re Hutchison, 104 F.2d 829, 42 USPQ 90, 93 (C.C.P.A. 1939) the court said, “It is realized that “substantial distance” is a relative and somewhat indefinite term, or phrase, but terms and phrases of this character are not uncommon in patents in cases where, according to the art involved, the meaning can be determined with reasonable clearness.”

Hence, for at least the forgoing reason, Applicants submit that it is improper for any examiner to hold as indefinite any claims of the present patent that employ any words of approximation.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will be described in detail below with reference to embodiments thereof as illustrated in the accompanying drawings.

References to a “device,” an “apparatus,” a “system,” etc., in the preamble of a claim should be construed broadly to mean “any structure meeting the claim terms” exempt for any specific structure(s)/type(s) that has/(have) been explicitly disavowed or excluded or admitted/implied as prior art in the present specification or incapable of enabling an object/aspect/goal of the invention. Furthermore, where the present specification discloses an object, aspect, function, goal, result, or advantage of the invention that a specific prior art structure and/or method step is similarly capable of performing yet in a very different way, the present invention disclosure is intended to and shall also implicitly include and cover additional corresponding alternative embodiments that are otherwise identical to that explicitly disclosed except that they exclude such prior art structure(s)/step(s), and shall accordingly be deemed as providing sufficient disclosure to support a corresponding negative limitation in a claim claiming such alternative embodiment(s), which exclude such very different prior art structure(s)/step(s) way(s).

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable sub combination. The Applicants hereby give notice that new Claims may be formulated to such features and/or combinations of such features during the prosecution of the present Application or of any further Application derived therefrom.

References to “one embodiment,” “an embodiment,” “example embodiment,” “various embodiments,” “some embodiments,” “embodiments of the invention,” etc., may indicate that the embodiment(s) of the invention so described may include a particular feature, structure, or characteristic, but not every possible embodiment of the invention necessarily includes the particular feature, structure, or characteristic. Further, repeated use of the phrase “in one embodiment,” or “in an exemplary embodiment,” “an embodiment,” do not necessarily refer to the same embodiment, although they may. Moreover, any use of phrases like “embodiments” in connection with “the invention” are never meant to characterize that all embodiments of the invention must include the particular feature, structure, or characteristic, and should instead be understood to mean “at least some embodiments of the invention” include the stated particular feature, structure, or characteristic.

References to “user”, or any similar term, as used herein, may mean a human or non-human user thereof. Moreover, “user”, or any similar term, as used herein, unless expressly stipulated otherwise, is contemplated to mean users at any stage of the usage process, to include, without limitation, direct user(s), intermediate user(s), indirect user(s), and end user(s). The meaning of “user”, or any similar term, as used herein, should not be otherwise inferred, or induced by any pattern(s) of description, embodiments, examples, or referenced prior-art that may (or may not) be provided in the present patent.

References to “end user”, or any similar term, as used herein, is generally intended to mean late-stage user(s) as opposed to early-stage user(s). Hence, it is contemplated that there may be a multiplicity of different types of “end user” near the end stage of the usage process. Where applicable, especially with respect to distribution channels of embodiments of the invention comprising consumed retail products/services thereof (as opposed to sellers/vendors or Original Equipment Manufacturers), examples of an “end user” may include, without limitation, a “consumer”, “buyer”, “customer”, “purchaser”, “shopper”, “enjoyer”, “viewer”, or individual person or non-human thing benefiting in any way, directly or indirectly, from use of. or interaction, with some aspect of the present invention.

In some situations, some embodiments of the present invention may provide beneficial usage to more than one stage or type of usage in the foregoing usage process. In such cases where multiple embodiments targeting various stages of the usage process are described, references to “end user”, or any similar term, as used therein, are generally intended to not include the user that is the furthest removed, in the foregoing usage process, from the final user therein of an embodiment of the present invention.

Where applicable, especially with respect to retail distribution channels of embodiments of the invention, intermediate user(s) may include, without limitation, any individual person or non-human thing benefiting in any way, directly or indirectly, from use of, or interaction with, some aspect of the present invention with respect to selling, vending, Original Equipment Manufacturing, marketing, merchandising, distributing, service providing, and the like thereof.

References to “person”, “individual”, “human”, “a party”, “animal”, “creature”, or any similar term, as used herein, even if the context or particular embodiment implies living user, maker, or participant, it should be understood that such characterizations are sole by way of example, and not limitation, in that it is contemplated that any such usage, making, or participation by a living entity in connection with making, using, and/or participating, in any way, with embodiments of the present invention may be substituted by such similar performed by a suitably configured non-living entity, to include, without limitation, automated machines, robots, humanoids, computational systems, information processing systems, artificially intelligent systems, and the like. It is further contemplated that those skilled in the art will readily recognize the practical situations where such living makers, users, and/or participants with embodiments of the present invention may be in whole, or in part, replaced with such non-living makers, users, and/or participants with embodiments of the present invention. Likewise, when those skilled in the art identify such practical situations where such living makers, users, and/or participants with embodiments of the present invention may be in whole, or in part, replaced with such non-living makers, it will be readily apparent in light of the teachings of the present invention how to adapt the described embodiments to be suitable for such non-living makers, users, and/or participants with embodiments of the present invention. Thus, the invention is thus to also cover all such modifications, equivalents, and alternatives falling within the spirit and scope of such adaptations and modifications, at least in part, for such non-living entities.

Headings provided herein are for convenience and are not to be taken as limiting the disclosure in any way.

The enumerated listing of items does not imply that any or all of the items are mutually exclusive, unless expressly specified otherwise.

It is understood that the use of specific component, device and/or parameter names are for example only and not meant to imply any limitations on the invention. The invention may thus be implemented with different nomenclature/terminology utilized to describe the mechanisms/units/structures/components/devices/parameters herein, without limitation. Each term utilized herein is to be given its broadest interpretation given the context in which that term is utilized.

Terminology. The following paragraphs provide definitions and/or context for terms found in this disclosure (including the appended claims):

“Comprising” And “contain” and variations of them—Such terms are open-ended and mean “including but not limited to”. When employed in the appended claims, this term does not foreclose additional structure or steps. Consider a claim that recites: “A memory controller comprising a system cache . . . ” Such a claim does not foreclose the memory controller from including additional components (e.g., a memory channel unit, a switch).

“Configured To.” Various units, circuits, or other components may be described or claimed as “configured to” perform a task or tasks. In such contexts, “configured to” or “operable for” is used to connote structure by indicating that the mechanisms/units/circuits/components include structure (e.g., circuitry and/or mechanisms) that performs the task or tasks during operation. As such, the mechanisms/unit/circuit/component can be said to be configured to (or be operable) for perform(ing) the task even when the specified mechanisms/unit/circuit/component is not currently operational (e.g., is not on). The mechanisms/units/circuits/components used with the “configured to” or “operable for” language include hardware—for example, mechanisms, structures, electronics, circuits, memory storing program instructions executable to implement the operation, etc. Reciting that a mechanism/unit/circuit/component is “configured to” or “operable for” perform(ing) one or more tasks is expressly intended not to invoke 35 U.S.C . . . sctn.112, sixth paragraph, for that mechanism/unit/circuit/component. “Configured to” may also include adapting a manufacturing process to fabricate devices or components that are adapted to implement or perform one or more tasks.

“Based On.” As used herein, this term is used to describe one or more factors that affect a determination. This term does not foreclose additional factors that may affect a determination. That is, a determination may be solely based on those factors or based, at least in part, on those factors. Consider the phrase “determine A based on B.” While B may be a factor that affects the determination of A, such a phrase does not foreclose the determination of A from also being based on C. In other instances, A may be determined based solely on B.

The terms “a”, “an” and “the” mean “one or more”, unless expressly specified otherwise.

All terms of exemplary language (e.g., including, without limitation, “such as”, “like”, “for example”, “for instance”, “similar to”, etc.) are not exclusive of any other, potentially, unrelated, types of examples; thus, implicitly mean “by way of example, and not limitation . . . ”, unless expressly specified otherwise.

Unless otherwise indicated, all numbers expressing conditions, concentrations, dimensions, and so forth used in the specification and claims are to be understood as being modified in all instances by the term “about.” Accordingly, unless indicated to the contrary, the numerical parameters set forth in the following specification and attached claims are approximations that may vary depending at least upon a specific analytical technique.

The term “comprising,” which is synonymous with “including,” “containing,” or “characterized by” is inclusive or open-ended and does not exclude additional, unrecited elements or method steps. “Comprising” is a term of art used in claim language which means that the named claim elements are essential, but other claim elements may be added and still form a construct within the scope of the claim.

As used herein, the phase “consisting of” excludes any element, step, or ingredient not specified in the claim. When the phrase “consists of” (or variations thereof) appears in a clause of the body of a claim, rather than immediately following the preamble, it limits only the element set forth in that clause; other elements are not excluded from the claim as a whole. As used herein, the phase “consisting essentially of” and “consisting of” limits the scope of a claim to the specified elements or method steps, plus those that do not materially affect the basis and novel characteristic(s) of the claimed subject matter (see Norian Corp. v Stryker Corp., 363 F.3d 1321, 1331-32, 70 USPQ2d 1508, Fed. Cir. 2004). Moreover, for any claim of the present invention which claims an embodiment “consisting essentially of” or “consisting of” a certain set of elements of any herein described embodiment it shall be understood as obvious by those skilled in the art that the present invention also covers all possible varying scope variants of any described embodiment(s) that are each exclusively (i.e., “consisting essentially of”) functional subsets or functional combination thereof such that each of these plurality of exclusive varying scope variants each consists essentially of any functional subset(s) and/or functional combination(s) of any set of elements of any described embodiment(s) to the exclusion of any others not set forth therein. That is, it is contemplated that it will be obvious to those skilled how to create a multiplicity of alternate embodiments of the present invention that simply consisting essentially of a certain functional combination of elements of any described embodiment(s) to the exclusion of any others not set forth therein, and the invention thus covers all such exclusive embodiments as if they were each described herein.

With respect to the terms “comprising,” “consisting of,” and “consisting essentially of,” where one of these three terms is used herein, the disclosed and claimed subject matter may include the use of either of the other two terms. Thus, in some embodiments not otherwise explicitly recited, any instance of “comprising” may be replaced by “consisting of” or, alternatively, by “consisting essentially of”, and thus, for the purposes of claim support and construction for “consisting of” format claims, such replacements operate to create yet other alternative embodiments “consisting essentially of” only the elements recited in the original “comprising” embodiment to the exclusion of all other elements.

Moreover, any claim limitation phrased in functional limitation terms covered by 35 USC § 112(6) (post AIA 112(f)) which has a preamble invoking the closed terms “consisting of,” or “consisting essentially of,” should be understood to mean that the corresponding structure(s) disclosed herein define the exact metes and bounds of what the so claimed invention embodiment(s) consists of, or consisting essentially of, to the exclusion of any other elements which do not materially affect the intended purpose of the so claimed embodiment(s).

Devices or system modules that are in at least general communication with each other need not be in continuous communication with each other, unless expressly specified otherwise. In addition, devices or system modules that are in at least general communication with each other may communicate directly or indirectly through one or more intermediaries. Moreover, it is understood that any system components described or named in any embodiment or claimed herein may be grouped or sub-grouped (and accordingly implicitly renamed) in any combination or sub-combination as those skilled in the art can imagine as suitable for the particular application, and still be within the scope and spirit of the claimed embodiments of the present invention. For an example of what this means, if the invention was a controller of a motor and a valve and the embodiments and claims articulated those components as being separately grouped and connected, applying the foregoing would mean that such an invention and claims would also implicitly cover the valve being grouped inside the motor and the controller being a remote controller with no direct physical connection to the motor or internalized valve, as such the claimed invention is contemplated to cover all ways of grouping and/or adding of intermediate components or systems that still substantially achieve the intended result of the invention.

A description of an embodiment with several components in communication with each other does not imply that all such components are required. On the contrary a variety of optional components are described to illustrate the wide variety of possible embodiments of the present invention.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still cooperate or interact with each other.

It is to be understood that any exact measurements/dimensions or particular construction materials indicated herein are solely provided as examples of suitable configurations and are not intended to be limiting in any way. Depending on the needs of the particular application, those skilled in the art will readily recognize, in light of the following teachings, a multiplicity of suitable alternative implementation details.

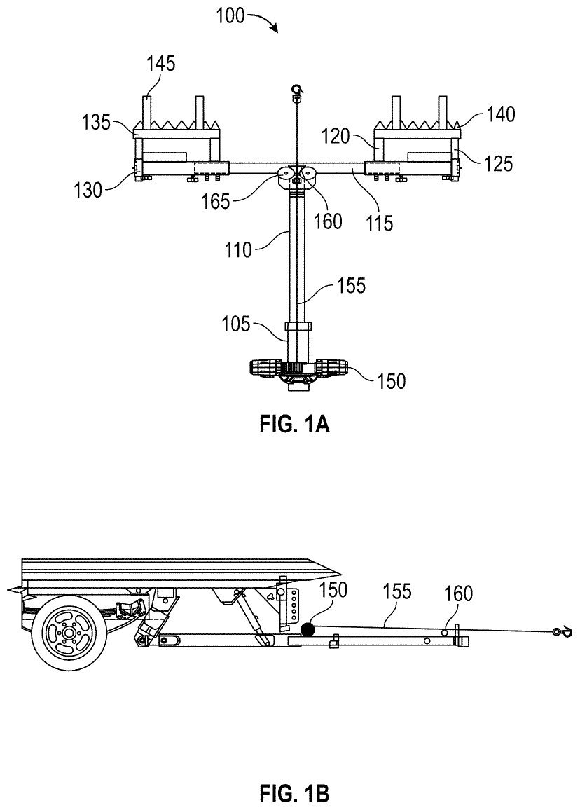

FIGS. 1A-1B illustrate an exemplary self-contained winch mounting system, wherein FIG. 1A shows a top view of a self-contained winch mounting system and FIG. 1B shows a side view of a self-contained winch mounting system, in accordance with an embodiment of the present invention. Self-contained mounting system 100 may use an additional winch mounted to a wheel-lift of a recovery vehicle to provide an additional means for recovering disabled vehicles while reducing damage to the recovery vehicle itself. The installation of self-contained mounting system may require the removal of the arms and pulleys of a standard wheel-lift, and replacement with a counter pressure system or mechanism and a winching mechanism, as will be described in greater detail below. Self-contained mounting system 100 may utilize a counter pressure system comprising a wheel lift including wheel lift base plate 105, retractable wheel lift arm 110, wheel lift brackets 115, free-floating support arms 120, L-arm attachment assembly 125, locking L-arm brackets 130, forward facing steel base plates 135, jagged edges 140, and forward-facing stabilizing arms 145. The counter pressure system may transfer pressure from winching a disabled vehicle from the wheel lift and distribute the pressure into the ground, reducing the overall strain of winching on the recovery vehicle. Wheel lift base plate 105 may act as a support for retractable wheel lift arm 110, increasing the stability of the overall counter pressure system, both while winching a vehicle and when using the wheel lift for towing purposes. Retractable wheel lift arm 110 may be retracted into a compact position underneath the truck bed of a recovery vehicle when not in use.

Each of arm of self-contained mounting system 100 may be secured using wheel lift brackets 115 and locking L-arm brackets 130. The wheel lift brackets 115 are adjustable arms that may move in and out to adjust to different widths of vehicles, they may be made wider for larger vehicles or narrower for smaller ones. The L-Arm brackets 130 may allow different types of L-arms to be inserted and locked in place to hold the drive wheels of cars as they are lifted off the ground. The tire of the car may be placed against the Wheel lift bracket 115 and then the L-arm is slid into the L-arm bracket 130 and locked, this wedges the wheel of the car in place, and it can be picked up. In the case of the BURD FIG. 100 the L-arms that would typically lift a car are replaced with L-arms that disperse the winching pressure. Base plates 135 may be attached to each wheel lift arm via free-floating support arm 120 and L-arm attachment assembly 125. Base plates 135 may be angled and have jagged edges 140 for ground penetration, providing additional support while winching. Rubber coverings could be added to the BURD to cover the jagged edges when winching on smooth hard surfaces, this would prevent damage to the hard surface. On ice it would be ideal to allow the teeth to penetrate. Additionally, forward facing stabilizing arms 145 may also be used to provide further counter-pressure against the force from winching, and when combined with jagged edges 140, distribute a majority of the pressure from winching into the ground. As such, the counter pressure system may provide for a stable base when utilizing a wheel-lift mounted winching mechanism.

The winching mechanism to be used with the counter pressure system may comprise winch implement 150, winch cable 155, cable guide 160 and pulley device 165 for the recovery of disabled vehicles. Winch implement 150 may be any type of winch known in the art, such as, without limitation, a pneumatic winch, hydraulic winch, electric winch, diesel winch, hand crank winch, etc. Winch implement 150 may be coupled to an appropriate power source, depending on the type of winch used. For example, without limitation, winch implement 150 may be coupled to the hydraulic system of the recovery vehicle, an external battery, an air compressor, etc. Winch cable 155 may be laid across retractable wheel lift arm 110 when in use, and threaded through cable guide 160. The wheel lift may pivot from left to right allowing for better angles of winching, but it only pivots at the bushing where pully device 165 and cable guide 160 is located. The pulley device will allow for pivoting but also a straight pull on the winching cable 155 allowing it to respool correctly. Cable guide 160 may include pulley device 165 such that winch cable 155 may be adjusted horizontally, vertically, and angled as needed depending on the location of the disabled vehicle. As such, the winching mechanism may be adjusted to recover vehicles in a variety of different locations and scenarios.

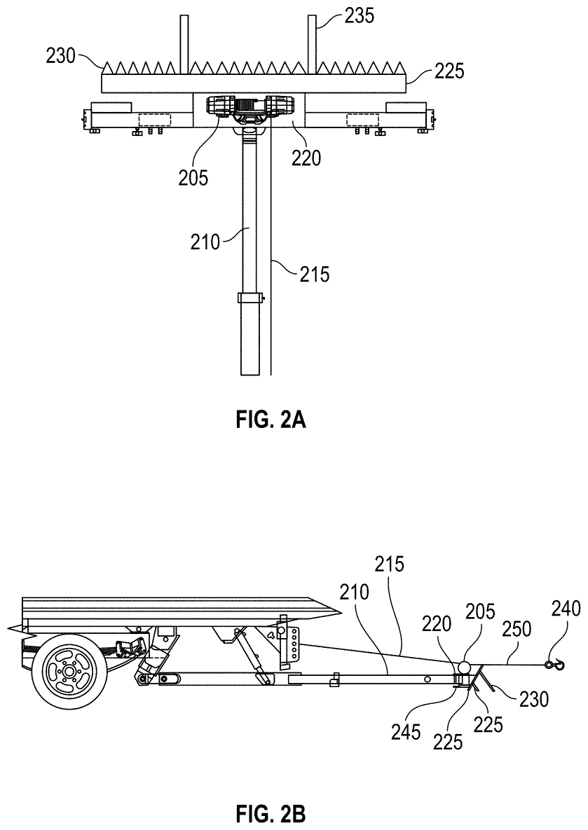

In some embodiments, two horizontal steel plates may mount directly to a wheel lift of a tow truck (the wheel lift being sandwiched between the two plates) using one or more pieces of hardware including but not a limited to, bolt and spacer, pin, bushing, etc. A mounting bracket may include a winch mounted so that it sits securely above the wheel lift on a top steel plate. In addition, the mounting bracket may mount an operating electric, hydraulic, or pneumatic winch to the wheel lift of any tow truck. The winch mount may include a vertical steel plate that connects the two horizontal steel plates together. The vertical steel plate may be angled slightly forward at the top with another smaller steel plate angled forward at the bottom. One or more arms may be attached to the horizontal plate that may brace the structure and distribute pressure. A wiring harness may connect to the tow truck for electric/hydraulic/pneumatic power and winch control. FIGS. 2A-2B illustrate an exemplary BURD, wherein FIG. 2A shows a top view of a BURD and FIG. 2B shows a side view of a BURD, in accordance with an embodiment of the present invention. As opposed to self-contained winch mounting system 100 as described above which may be permanently installed onto a wheel lift of a recovery vehicle, BURD 200 may be easily installed and removed from a wheel lift, and may be a more flexible means for recovering a disabled vehicle. Additionally, the installation of BURD 200 may be a low-cost solution when compared to more conventional approaches, such as, without limitation, side-pull systems, and may not be limited to being installed on the side of a recovery vehicle, allowing for more flexibility when in use. A small mounting bracket could be placed on the side of the truck to allow it to be mounted under the roll back bed, however this would be difficult to lift due to the weight and no hydraulics assisting it. Mounting brackets could be made for a pickup, however the unit would be heavy and difficult to lift into position. Straps could be added to the BURD so it could operate away from the tow truck as long as the power source could reach i.e., it could be attached to a tree and run as long as the power cord could reach the unit. BURD 200 may include winch 205 which may be mounted on winch mount top plate 220 and powered by connector cables 215. Connector cables 215 may include quick-connect adaptors for quick installation, and may be connected to different power sources of a recovery vehicle depending on the needs of the user. For example, without limitation, connector cables 215 may be pneumatic lines, hydraulic lines, electric lines, etc. Winch 205 may be securely mounted onto winch mount top plate 220 and winch mount bottom plate 250 via any means known in the art, such as, without limitation, nuts, bolts, pins, etc. BURD 200 may be installed such that there may be adequate clearance (e.g., 10-15 inches) above winch mount top plate 220 to allow for the attachment of additional accessories, such as, without limitation, winching points, rings, hooks, etc. Additionally, adequate bottom clearance (e.g., 1-3 inches) beneath winch mount bottom plate 245 may be provided to allow for the full operation of the roll back bed. The wheel lift that is attached to the roll back may be retracted and leaves enough room for the roll back bed to move back and down far enough to make contact with the ground forming a ramp that the vehicle is pulled upon and then strapped down to, the bed is then retracted and the vehicle rides on the roll back bed until it is time to remove the vehicle. As long as the BURD fits inside the area reserved for the wheel lift the roll back bed should be operational. The wheel lift has between 10-15 inches of clearance above it when the bed is extended and 1-3 inches below it when the bed is extended. This should allow enough room for the BURD to be mounted along with any standard winch. Forward-facing plate 225 may be a base for additional stabilization means of BURD 200, which may be used to distribute stress from winching a disabled vehicle into the ground. For example, without limitation, forward-facing plate 225 may include jagged teeth 230 and forward-facing arms 235 for additional stabilization. Jagged teeth 230 may be attached to the bottom of forward-facing plate 225, and may dig into the ground when deployed. Forward-facing arms 235, likewise, may be attached to forward-facing plate 225 and may redirect pressure from the winching mechanism into the ground and away from the wheel lift and truck frame. In the present embodiment, two forward-facing arms 235 may be used to provide additional support to BURD 200. However, as will be appreciated by one skilled in the art, BURD 200 may include additional forward-facing arms 235 as needed by the user. Forward-facing arms 235 may also include motors for ease of deployment and to create additional downward pressure when deployed for additional stability. When deployed, winch 205 may extend winch line 250 and tow hook 240 to be attached to chains/cables secured to a disabled vehicle.

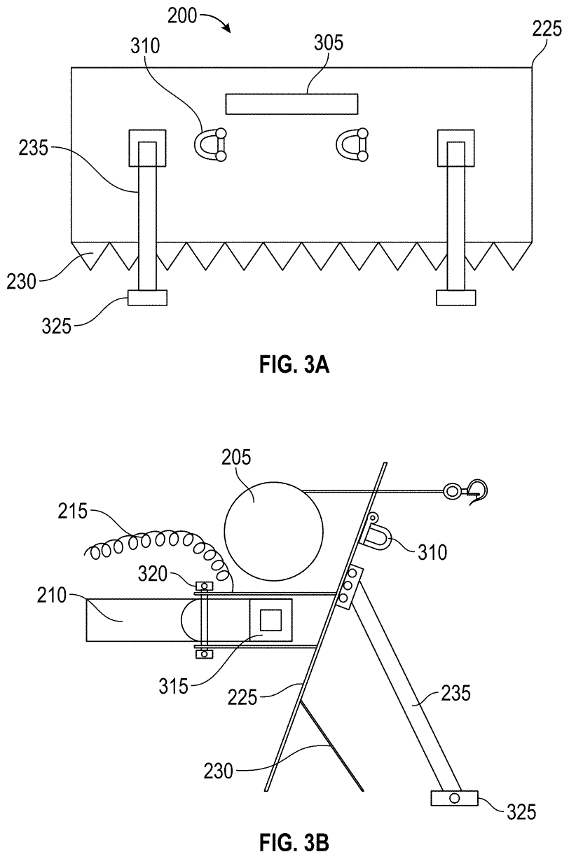

FIGS. 3A-3B illustrate an exemplary BURD, wherein FIG. 3A shows a front view of a BURD and FIG. 3B shows a side view of a BURD, in accordance with an embodiment of the present invention. With reference to both FIGS. 2A-2B and FIGS. 3A-3B, BURD 200 winch line 250 may pass through forward-facing plate 225 via winch line hole 305, allowing lower placement of winch 205. Forward-facing plate 225 may be trimmed down lower to allow the winch line 250 to pass over the forward-facing plate 225. One or more snatch blocks may also be attached to BURD 200 via, for example, without limitation, D-ring attachment 310. In the present embodiment, two D-ring attachments may be used for snatch block anchoring. However, as will be appreciated by one skilled in the art, additional mounting points for the snatch block may also be used, and different types of attachment points may be available, such as, without limitation, hooks, rings, Hooks, Clevises, Shackles, etc. To further increase the traction capabilities of forward-facing legs 235, feet 325 may be coupled to the ends of forward-facing legs 235 opposite forward-facing plate 225. Feet 325 may include different types of bottom padding, such as, without limitation, rubber, jagged edged, etc. to further increase friction and prevent slippage. BURD 200 may be attached to wheel lift arm 210 via, for example, without limitation, mounting bracket 315, which is similar to the wheel lift bracket 115 in FIG. 1A. Mounting bracket 315 may be easily secured via bolt 320. The mounting bracket 315 can be attached using pins, nuts and bolts, quick attach connector. Optionally, stabilizing chains and/or cables may be mounted to the recovery vehicle and BURD 200 to provide further support.

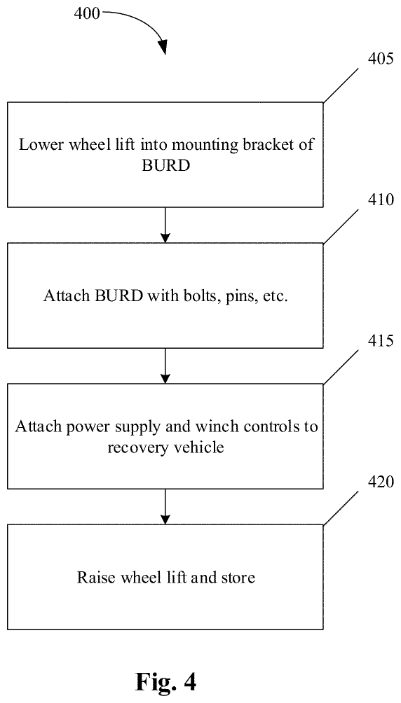

FIG. 4 illustrates a flowchart of an exemplary method for installing a BURD, in accordance with an embodiment of the present invention. A BURD may be easily and quickly be installed by one person, allowing for a cost-effective means for efficient vehicle recovery. In a step 405 of method 400, a wheel lift of a recovery vehicle may be lowered into the mounting bracket of a BURD. Proper alignment of the mounting bracket with the wheel lift may be required for proper installation. The wheel lift itself just needs to be able to fit in between the top plate 220 and bottom plate 245. Once it is between the two plates, there needs to be enough room to insert the pins or bolts behind the wheel lift to ensure that it does not slip out the back of the mounting bracket. In a step 410 of method 400, fastening means, such as, without limitation, bolts, pins, spacers, etc. may be used to attach the BURD to the wheel lift of the recovery vehicle. Once the fastening means are installed, the BURD may be secured in place. A power source and winch controls may then be attached to the recovery vehicle in a step 415 of method 400. The power source may be, for example, without limitation, a pneumatic system, hydraulic system, electrical system, etc. The type of power source may depend on the needs of the user, and may be replaceable as needed. Additionally, the winch controls and power source may be mounted at any suitable location on the recovery vehicle. Optimal locations may vary depending on the specific make and model of the vehicle. The wheel lift may then be lifted and stored away in a step 420 of method 400.

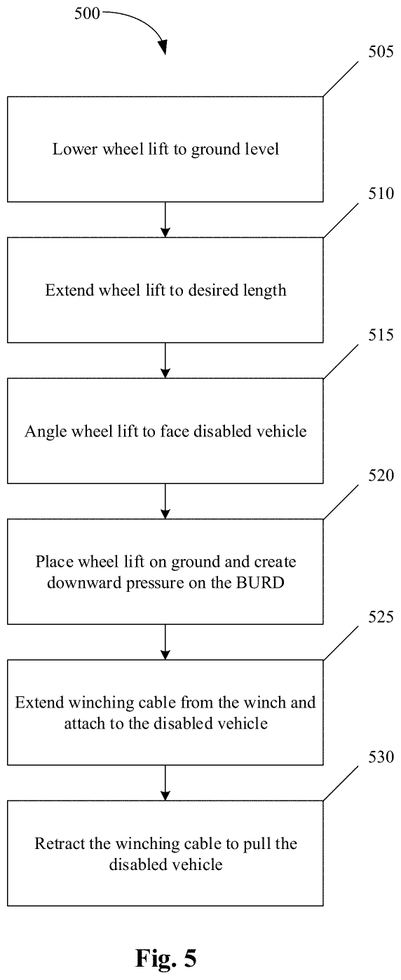

FIG. 5 illustrates a flowchart of an exemplary method for deploying a BURD for use, in accordance with an embodiment of the present invention. The BURD may also be easily operable by one person when being used to efficiently recover a disabled vehicle. Method 500 may begin with an initial step 505 in which a wheel lift with installed BURD may be lowered to ground level. The wheel lift may be lowered above the ground such that additional adjustments may be made, as needed depending on the specific recovery scenario. In a step 510 of method 500, the wheel lift may be extended to a desired length to allow for proper clearance and positioning of the BURD. The wheel lift may then be angled or moved at an angle to face the disabled vehicle in a step 515 of method 500. Some wheel lifts may move from left to right by hand, some wheel lifts may have hydraulics that move the wheel lift from left to right. The wheel lift should be angled to allow for the straightest pull and winding of the winching cable possible. Snatch blocks may be placed anywhere along the winch line 250 to allow for a straighter pull. Snatch blocks may also be attached to the vehicle and then the winch line can come back and be attached to an attachment on the BURD. This may create double the pulling power by turning one winch line into two (this method is well known in the towing community and can be repeated many times to increase pulling power). Method 500 may then continue with a step 520 in which the wheel lift may be placed on the ground and downward pressure may be placed or applied on the BURD. The downward pressure may be applied by, for example, without limitation, pushing the hydraulics of the wheel lift into the ground. Creating downward pressure on the BURD may reduce pressure on the wheel lift by dispersing the pressure into the ground via the jagged edges and the front-facing arms of the BURD. The winching cable may then be extended from the winch and attached to the disabled vehicle in a step 525 of method 500. The winching cable may be attached to the disabled vehicle by any means known in the art, and may include that attachment of additional chains and/or cables for proper recovery. The disabled vehicle may then be pulled by retracting the winching cable. In FIG. 1A the L-arms can be removed, and towing L-arms can take their place allowing for a vehicle to be towed. In FIG. 2A the entire BURD system will have to be removed in order to tow a vehicle, however if a roll back tow truck is being used then the roll back bed can still be used to tow a vehicle while the BURD is still attached.

Those skilled in the art will readily recognize, in light of and in accordance with the teachings of the present invention, that any of the foregoing steps may be suitably replaced, reordered, removed and additional steps may be inserted depending upon the needs of the particular application. Moreover, the prescribed method steps of the foregoing embodiments may be implemented using any physical and/or hardware system that those skilled in the art will readily know is suitable in light of the foregoing teachings. For any method steps described in the present application that can be carried out on a computing machine, a typical computer system can, when appropriately configured or designed, serve as a computer system in which those aspects of the invention may be embodied.

In additional embodiments, a simple winch mount may be added to a wheel lift. Where a mounting bracket may allow a winch to be connected. In alternative embodiments, a winch and mounting bracket that has chains or rods may be attached, where the chains and rods may be adjustable, and the winch could be angled with the wheel lift. The chains and rods may distribute the winching pressure to the truck or whatever they were attached to. In other alternative embodiments, a winch may be mounted to a bracket that can replace the wheel lift entirely. By removing the wheel lift head and taking the wheel lift assembly completely, the mounting bracket may be attached to the wheel lift arm by a single bushing. This would permanently attach the winch to the tow truck always making it available. This would be the same as the finished BURD device with the forward-facing arms and jagged teeth, the only difference would be that it is mounted in place of the wheel lift, not attached to the wheel lift.

In some embodiments, a winch may be mounted to the wheel lift with a forward-facing plate and jagged edge teeth that penetrate the ground. One or more arms that extend out and push into the ground using electric motors or hydraulic powered arms may provide more pressure into the ground, making the device more stable.

In other embodiments, a winch may be mounted to the wheel lift with a forward-facing plate and jagged edge teeth that penetrate the ground, and one or more arms may extend out and push into the ground. The apparatus may attach to two square tubes that slide into position where the L-arms would typically be installed for normal operation of the wheel lift. This may eliminate the two horizontal steel plates that bolt together around the wheel lift and just leave a spot to mount a winch.

In some embodiments, a winch may be permanently fixed to the wheel lift, where the winch line may run to the head of the wheel lift where several pullies can be attached to angle the line and allow it to run. Two arms may lock into place where the L-arms typically go, these arms may have jagged teeth and forward-facing arms. The jagged edge may penetrate the ground and the forward-facing arms may redirect the pressure to the ground. This may be a permanent addition and the wheel lift could be used by simply removing the arms and pulleys and storing them away.

In some embodiments, a winch may be mounted to the wheel lift with a forward-facing plate and jagged edge teeth that penetrate the ground. One or more arms may extend out and push into the ground with two square tubes that may slide into place on the wheel lift bracket. The square tubes may have holes in place that allow for pinholes in the BURD to line up and connect to the wheel lift easily.

In some embodiments, the material used such as but not limited to steel and aluminum may be strong enough to withstand the force of winching a 2000 to 15000 lbs vehicle from a stuck position (mud, sand, water, snow, ice, etc.) Steel may be the ideal component due to its strength and relative low cost. However, it may be excessively heavy. Aluminum may be used to construct the BURD device, but the strength limitations would have to be known to the operator.

All the features disclosed in this specification, including any accompanying abstract and drawings, may be replaced by alternative features serving the same, equivalent, or similar purpose, unless expressly stated otherwise. Thus, unless expressly stated otherwise, each feature disclosed is one example only of a generic series of equivalent or similar features.

It is noted that according to USA law 35 USC § 112 (1), all claims must be supported by sufficient disclosure in the present patent specification, and any material known to those skilled in the art need not be explicitly disclosed. However, 35 USC § 112 (6) requires that structures corresponding to functional limitations interpreted under 35 USC § 112 (6) must be explicitly disclosed in the patent specification. Moreover, the USPTO's Examination policy of initially treating and searching prior art under the broadest interpretation of a “mean for” or “steps for” claim limitation implies that the broadest initial search on 35 USC § 112(6) (post AIA 112(f)) functional limitation would have to be conducted to support a legally valid Examination on that USPTO policy for broadest interpretation of “mean for” claims. Accordingly, the USPTO will have discovered a multiplicity of prior art documents including disclosure of specific structures and elements which are suitable to act as corresponding structures to satisfy all functional limitations in the below claims that are interpreted under 35 USC § 112(6) (post AIA 112(f)) when such corresponding structures are not explicitly disclosed in the foregoing patent specification. Therefore, for any invention element(s)/structure(s) corresponding to functional claim limitation(s), in the below claims interpreted under 35 USC § 112(6) (post AIA 112(f)), which is/are not explicitly disclosed in the foregoing patent specification, yet do exist in the patent and/or non-patent documents found during the course of USPTO searching, Applicant(s) incorporate all such functionally corresponding structures and related enabling material herein by reference for the purpose of providing explicit structures that implement the functional means claimed. Applicant(s) request(s) that fact finders during any claims construction proceedings and/or examination of patent allowability properly identify and incorporate only the portions of each of these documents discovered during the broadest interpretation search of 35 USC § 112(6) (post AIA 112(f)) limitation, which exist in at least one of the patent and/or non-patent documents found during the course of normal USPTO searching and or supplied to the USPTO during prosecution. Applicant(s) also incorporate by reference the bibliographic citation information to identify all such documents comprising functionally corresponding structures and related enabling material as listed in any PTO Form-892 or likewise any information disclosure statements (IDS) entered into the present patent application by the USPTO or Applicant(s) or any 3^{rd} parties. Applicant(s) also reserve its right to later amend the present application to explicitly include citations to such documents and/or explicitly include the functionally corresponding structures which were incorporate by reference above.

Thus, for any invention element(s)/structure(s) corresponding to functional claim limitation(s), in the below claims, that are interpreted under 35 USC § 112(6) (post AIA 112(f)), which is/are not explicitly disclosed in the foregoing patent specification, Applicant(s) have explicitly prescribed which documents and material to include the otherwise missing disclosure, and have prescribed exactly which portions of such patent and/or non-patent documents should be incorporated by such reference for the purpose of satisfying the disclosure requirements of 35 USC § 112 (6). Applicant(s) note that all the identified documents above which are incorporated by reference to satisfy 35 USC § 112 (6) necessarily have a filing and/or publication date prior to that of the instant application, and thus are valid prior documents to incorporated by reference in the instant application.

Having fully described at least one embodiment of the present invention, other equivalent or alternative methods of implementing a BURD according to the present invention will be apparent to those skilled in the art. Various aspects of the invention have been described above by way of illustration, and the specific embodiments disclosed are not intended to limit the invention to the particular forms disclosed. The particular implementation of the BURD may vary depending upon the particular context or application. By way of example, and not limitation, the BURD described in the foregoing were principally directed to disabled vehicle recovery implementations; however, similar techniques may instead be applied to object retrieval, which implementations of the present invention are contemplated as within the scope of the present invention. The invention is thus to cover all modifications, equivalents, and alternatives falling within the spirit and scope of the following claims. It is to be further understood that not all of the disclosed embodiments in the foregoing specification will necessarily satisfy or achieve each of the objects, advantages, or improvements described in the foregoing specification.

Claim elements and steps herein may have been numbered and/or lettered solely as an aid in readability and understanding. Any such numbering and lettering in itself is not intended to and should not be taken to indicate the ordering of elements and/or steps in the claims.

The corresponding structures, materials, acts, and equivalents of all means or step plus function elements in the claims below are intended to include any structure, material, or act for performing the function in combination with other claimed elements as specifically claimed.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The Abstract is provided to comply with 37 C.F.R. Section 1.72(b) requiring an abstract that will allow the reader to ascertain the nature and gist of the technical disclosure. That is, the Abstract is provided merely to introduce certain concepts and not to identify any key or essential features of the claimed subject matter. It is submitted with the understanding that it will not be used to limit or interpret the scope or meaning of the claims.

The following claims are hereby incorporated into the detailed description, with each claim standing on its own as a separate embodiment.

Only those claims which employ the words “means for” or “steps for” are to be interpreted under 35 USC 112, sixth paragraph (pre-AIA) or 35 USC 112(f) post-AIA. Otherwise, no limitations from the specification are to be read into any claims, unless those limitations are expressly included in the claims.

What is claimed is:

1. A system comprising:
a counter pressure mechanism, in which said counter pressure mechanism comprise:
a retractable wheel lift arm, wherein said retractable wheel lift arm is configured to retract into a compact position underneath a bed of a recovery vehicle when not in use;
a wheel lift base plate that is configured to be operable for supporting said retractable wheel lift arm, and increasing a stability of said counter pressure mechanism while winching a vehicle for towing purposes;
wherein said counter pressure mechanism is configured to be operable for transferring pressure from winching the vehicle to said wheel lift base plate and distribute the pressure into a ground; and
a wheel lift bracket having adjustable arms that are configured to move in and out to adjust to different widths of vehicles, wherein said adjustable arms are operable to be made wider for larger vehicles or narrower for smaller vehicles;
and
a winching mechanism, said winching mechanism comprise:
a winch implement;
a winch cable;
a cable guide; and
a pulley device.

2. The system according to claim 1, further comprising a free-floating support arm.

3. The system according to claim 2, further comprising a forward-facing steel base plate.

4. The system according to claim 0, further comprising a plurality of jagged edge.

5. The system according to claim 0, wherein said cable guide including said pulley device and winch cable are configured to be adjusted horizontally, vertically, and angled.

6. The system according to claim 0, further comprising a rubber covering that is configured to be operable for covering said jagged edges when winching on smooth hard surfaces and prevent damage to hard surfaces.

7. The system according to claim 0, further comprising a forward-facing stabilizing arm that is configured to provide further counter pressure against the force from winching.

8. The system according to claim 7, further comprising an L-arm attachment assembly.

9. The system according to claim 8, further comprising a locking L-arm bracket.

10. The system according to claim 1, further comprising:
at least two horizontal steel plates that is configured to mount to said wheel lift, wherein said wheel lift being sandwiched between the two horizontal steel plates;
a mounting bracket disposed above said wheel lift; and
a vertical steel plate for connecting the two horizontal steel plates.

11. A system comprising:
a winching mechanism for recovering or pulling a vehicle;
means for providing power to said winching mechanism;
means for guiding a winch cable;
means for transferring pressure from said winching mechanism from recovering or pulling a vehicle and distribute the pressure into a ground;
means for pivoting from left to right or right to left allowing for better angles of winching;
means for lifting the vehicle; and
means for adjusting a width of said vehicle lifting means.

12. A method comprising the steps of:
installing a Back Up Recovery Device (BURD) to at least one of, a recovery vehicle and a tow truck, in which said BURD comprise a wheel lift;
lowering said wheel lift to ground level;
extending said wheel lift to a predetermined length;
moving said wheel lift at an angled position to face a vehicle being recovered;
placing said wheel lift on the ground;
applying a downward pressure on the BURD;
extending a winching cable;
attaching said winching cable to the vehicle;
retracting said winching cable to pull the vehicle;

13. The method of claim 12, in which said step of installing a Back Up Recovery Device (BURD) to a recovery vehicle comprise:
installing said wheel lift including a counter pressure mechanism; and
installing a winch device including a winching mechanism.

14. The method of claim 13, in which said counter pressure mechanism comprise:
a retractable wheel lift arm, wherein said retractable wheel lift arm is configured to retract into a compact position underneath a bed of a recovery vehicle when not in use;
a wheel lift base plate that is configured to be operable for supporting said retractable wheel lift arm, and increasing a stability of said counter pressure mechanism while winching a vehicle for towing purposes;
wherein said counter pressure mechanism is configured to be operable for transferring pressure from winching the vehicle to said wheel lift base plate and distribute the pressure into a ground; and
a wheel lift bracket having adjustable arms that are configured to move in and out to adjust to different widths of vehicles, wherein said adjustable arms are operable to be made wider for larger vehicles or narrower for smaller vehicles;

15. The method of claim 14, in which said counter pressure mechanism further comprise:
a free-floating support arm;
a forward-facing steel base plate; and
a plurality of jagged edge.

16. The method of claim 15, in which said counter pressure mechanism further comprise:
a plurality of jagged edge; and
a forward-facing stabilizing arm that is configured to provide further counter pressure against the force from winching.

17. The method of claim 12, in which said counter pressure mechanism comprise:
a wheel lift bracket; and
an L-Arm bracket;

18. The method of claim 12, in which said winching mechanism comprise:
a winch implement;
a winch cable;
a cable guide; and
a pulley device.

19. The method of claim 12, further comprising the steps of:
mounting two horizontal steel plates to the wheel lift of the tow truck;
disposing the wheel lift between the two plates;
mounting a winch above the wheel lift;

20. The method of claim 19, further comprising the steps of:
connecting the two horizontal plates together with a vertical steel plate;
placing the vertical steel plate at an angle;
attaching one or more arms to the horizontal plates to distribute pressure;
connecting a wiring harness to the tow truck for providing at least one of, an electric power, a hydraulic power, and a pneumatic power for winch control.
